(19) United States
(12) Patent Application Publication
(10) Pub. No.: US 2015/0223488 A1
(43) Pub. Date: Aug. 13, 2015

(54) FLAVOR PRE-BLEND OF INGREDIENTS FOR CHEWING GUM, METHODS OF MAKING PRE-BLEND INGREDIENTS AND CHEWING GUM COMPOSITIONS THEREOF

(71) Applicant: INTERCONTINENTAL GREAT BRANDS LLC, EAST HANOVER, NJ (US)

(72) Inventors: Kishor Kabse, Whippany, NJ (US); Navroz Boghani, Whippany, NJ (US); Petros Gebreselassie, Whippany, NJ (US); Leonard Scarola, Whippany, NJ (US); Jareer Abu-Ali, Whippany, NJ (US)

(21) Appl. No.: 14/422,581

(22) PCT Filed: Jun. 11, 2013
(86) PCT No.: PCT/US2013/045066

§ 371 Date: Feb. 19, 2015

Related U.S. Application Data
(60) Provisional application No. 61/691,916, filed on Aug. 22, 2012.

(51) Int. Cl. A23G 4/06; A23G 4/10

(52) U.S. Cl. CPC A23G 4/06; A23G 4/10

(57) ABSTRACT

Pre-blend and flavor pre-blend ingredients for use in the preparation of chewing gum is described. The pre-blend and flavor pre-blend ingredients include hydrophilic and lipophilic ingredients combined prior to blending with gum base and other chewing gum ingredients.

### FIELD

This disclosure generally relates to chewing gum, more specifically to chewing gum containing pre-blend ingredients.

### BACKGROUND

Traditional chewing gum is made using bulking agents in the form of crystalline powders such as crystalline sugar, sorbitol, or mannitol. Chewing gum is generally designed to have a certain chew texture throughout the majority of the chew time. However, designing for a targeted chew texture is complicated by the fact that the temperature of the chewing gum at the initial bite occurs when the gum piece is at ambient temperature (˜22 to 25° C.). As the consumer continues to chew the gum piece, the gum reaches body temperature (37° C.). If the gum composition is designed to chew soft (“just right” chew) in the initial bite, then as the temperature increases, the chewing gum may become softer than a “just right” chew during the later chew stage. Thus, to design for a targeted chew texture during the majority of the chew duration, the initial chew may be harder than ideal. In such an instance, the consumer expectation of soft chew and large flavor hit in the first bite is not completely met by traditional chewing gum compositions.

An additional problem in the chewing gum art is ensuring sufficient flavor, sweeteners, and other ingredients are released from the chewing gum during the chewing process. Various flavors, sensates and other additives which may be of a hydrophobic nature, can get trapped in the hydrophobic chewing gum base. The result is an inefficient release or delayed release of flavors and reduced taste experience.

Furthermore, crystalline powder sugar polyols such as powder sorbitol, mannitol, and maltitol constitute a large portion of sugar-free chewing gums. Due to its large compositional proportion, the crystalline powder sugar polyol has a significant impact on a chewing gum's organoleptic quality. It contributes towards initial sensorial properties of taste, flavor release, mouth-feel and chew texture. Particle size and morphology of crystalline sorbitol, for example, also has significant impact on physical properties and manufacturing efficiencies of chewing gum.

Manufacturers of sugar polyol have differences in their manufacture namely process equipment selection and process variables which can lead to significant qualitative differences (particle size, morphology, porosity, mouth feel) of between the different powder sugar polyols resulting in uncertainties in gum process efficiencies. Such a direct relation of a powder sugar polyol's physical properties on chewing gum manufacturing process efficiency can place restrictions on chewing gum formulations and manufacturing capabilities.

There remains a need in the art for chewing gum exhibiting a just right chew texture from the initial stage of chew and throughout the majority of the chew time, while at the same time providing a large early release of flavor followed by a long lasting flavor profile.

In addition, there is a need in the art for sourcing powder bulk sugar polyol, such as sorbitol, from a variety of sources without regard to sugar polyol morphology or particle size.

### SUMMARY

In an embodiment, a chewing gum composition comprises a composition comprising a gum base; and a flavor pre-blend comprising i) a saccharide syrup or sugar alcohol syrup, ii) a viscosity enhancing agent that is protein, a hydrocolloid, talc, a polysaccharide, a polyethylene glycol, or a combination thereof, iii) an emulsifier, iv) a flavorant, v) a fat, and optionally vi) a food acid or salt thereof, a high intensity sweetener, a sensate, or a combination thereof; wherein the flavor pre-blend is prepared prior to combining with the composition comprising a gum base to form the chewing gum composition.

In an embodiment, a chewing gum composition comprises a composition comprising a gum base; and a flavor pre-blend comprising i) a saccharide syrup or sugar alcohol syrup, ii) a viscosity enhancing agent that is a protein, a hydrocolloid, talc, a polysaccharide, a polyethylene glycol, or a combination thereof, iii) an emulsifier, iv) a flavorant, v) a fat, and optionally vi) a food acid or salt thereof, a high intensity sweetener, a sensate, or a combination thereof; and wherein the chewing gum composition releases more flavor than a comparative chewing gum having identical type and amount of ingredients, wherein the ingredients i)-vi) are not prepared as a pre-blend.

In an embodiment, a chewing gum composition comprises a composition comprising a gum base and a bulk sweetener; and a flavor pre-blend comprising i) a sugar alcohol syrup, ii) a viscosity enhancing agent that is a protein, a hydrocolloid, talc, a polysaccharide, a polyethylene glycol, or a combination thereof, iii) an emulsifier, iv) a flavorant, v) a fat, and optionally vi) a humectant, a food acid or salt thereof, a high intensity sweetener, a sensate, or a combination thereof; wherein the flavor pre-blend is present in an amount of about 5 to about 65 wt % of the total chewing gum composition; and wherein the flavor pre-blend is prepared separately from the composition comprising a gum base and a bulk sweetener at a temperature less than or equal to 85° C., and then combined with the composition comprising a gum base and a bulk sweetener to form a homogeneous chewing gum composition.

In an embodiment, a chewing gum composition comprises a composition comprising a gum base; and a flavor pre-blend comprising i) a particulate saccharide or particulate sugar alcohol, ii) an amount of humectant sufficient to wet the particulate saccharide or particulate sugar alcohol wherein the humectant is glycerin, propylene glycol, or a combination thereof, iii) an emulsifier, iv) a flavorant, v) a fat, and optionally vi) water, a food acid or salt thereof, a high intensity sweetener, a sensate, or a combination thereof; wherein the flavor pre-blend is prepared prior to combining with the composition comprising a gum base to form the chewing gum composition.

In an embodiment, a chewing gum composition comprises a composition comprising a gum base; and a flavor pre-blend comprising i) a particulate saccharide or particulate sugar alcohol, ii) an amount of humectant sufficient to wet the particulate saccharide or particulate sugar alcohol wherein the humectant is glycerin, propylene glycol, or a combination thereof, iii) an emulsifier, iv) a flavorant, v) a fat, and optionally vi) water, a food acid or salt thereof, a high intensity sweetener, a sensate, or a combination thereof; and wherein the chewing gum composition releases more flavor than a comparative chewing gum having identical type and amount of ingredients, wherein the ingredients i)-vi) are not prepared as a pre-blend.

In an embodiment, a chewing gum composition comprises a composition comprising a gum base and a bulk sweetener; and a flavor pre-blend comprising i) a particulate saccharide or particulate sugar alcohol, ii) an amount of humectant sufficient to wet the particulate saccharide or particulate sugar alcohol wherein the humectant is glycerin, propylene glycol, or a combination thereof, iii) an emulsifier, iv) a flavorant, v) a fat, and optionally vi) water, a food acid or salt thereof, a high intensity sweetener, a sensate, or a combination thereof; wherein the flavor pre-blend is present in an amount of about 5 to about 65 wt % of the total chewing gum composition; and wherein the flavor pre-blend is prepared separately from the composition comprising a gum base and a bulk sweetener at a temperature less than or equal to 85° C., and then combined with the composition comprising a gum base and a bulk sweetener to form a homogeneous chewing gum composition.

In an embodiment, a chewing gum composition comprises a composition comprising a gum base; and a flavor pre-blend comprising i) a saccharide syrup or sugar alcohol syrup, ii) a particulate saccharide, particulate sugar alcohol, or a combination thereof, iii) a viscosity enhancing agent that is a protein, a hydrocolloid, talc, a polysaccharide, a polyethylene glycol, or a combination thereof, iv) a flavorant, v) a fat, and optionally vi) a food acid or salt thereof, a high intensity sweetener, a sensate, or a combination thereof; wherein the flavor pre-blend is prepared prior to combining with the composition comprising a gum base to form the chewing gum composition.

In an embodiment, a chewing gum composition comprises a composition comprising a gum base and a bulk sweetener; and a flavor pre-blend comprising i) a sugar alcohol syrup, ii) a particulate saccharide, particulate sugar alcohol or a combination thereof, iii) a viscosity enhancing agent that is a protein, a hydrocolloid, talc, a polysaccharide, a polyethylene glycol, or a combination thereof, iv) a flavorant, v) a fat, and optionally vi) a humectant, a food acid or salt thereof, a high intensity sweetener, a sensate, or a combination thereof; wherein the flavor pre-blend is present in an amount of about 5 to about 65 wt % of the total chewing gum composition; and wherein the flavor pre-blend is prepared separately from the composition comprising a gum base and a bulk sweetener at a temperature less than or equal to 85° C., and then combined with the composition comprising a gum base and a bulk sweetener to form a homogeneous chewing gum composition.

In an embodiment, a chewing gum composition comprises about 20 to about 50 wt % of a gum base; and about 20 to about 70% of a pre-blend, wherein the pre-blend comprises i) a sugar alcohol derived from a particulate sugar alcohol, ii) a saccharide syrup or sugar alcohol syrup, iii) an emulsifier, iv) a fat, and optionally v) a flavorant, a humectant, a food acid or salt thereof, a high intensity sweetener, a sensate, an inorganic powder, or a combination thereof; wherein the pre-blend is prepared prior to combining with the gum base to form the chewing gum composition; wherein the pre-blend comprises about 4 to about 10% moisture; and wherein the particulate sugar alcohol is wetted or dissolved by the saccharide syrup, sugar alcohol syrup, or a combination thereof.

In an embodiment, a chewing gum composition comprises about 20 to about 50 wt % of a gum base; and about 20 to about 70% of a pre-blend, wherein the pre-blend comprises i) a sugar alcohol derived from a particulate sugar alcohol, ii) a saccharide syrup or sugar alcohol syrup, iii) an emulsifier, iv) a fat, v) a humectant that is glycerin, propylene glycol, or a combination thereof, and optionally vi) a flavorant, a food acid or salt thereof, a high intensity sweetener, a sensate, an inorganic powder, or a combination thereof; wherein the pre-blend is prepared prior to combining with the gum base to form the chewing gum composition; wherein the pre-blend comprises about 4 to about 10% moisture; and wherein the particulate sugar alcohol is wetted or dissolved by the saccharide syrup, sugar alcohol syrup, or a combination thereof.

In an embodiment, a method of making a chewing gum composition comprises mixing gum base, optionally with a bulk sweetener, to form an intermediate chewing gum composition; and mixing the intermediate chewing gum composition with a flavor pre-blend or pre-blend to form a chewing gum composition.

The above described and other features are exemplified by the following detailed description.

### BRIEF DESCRIPTION OF THE DRAWING

FIG. 1A is a microscopy image of chewing gum made with crystalline powder sorbitol.

FIG. 1B is a microscopy image of chewing gum made with a sorbitol pre-blend where the sorbitol particles have been dissolved in the pre-blend.

### DETAILED DESCRIPTION

Disclosed herein are chewing gums comprising a gum base; optionally a bulk sweetener; and a flavor pre-blend or pre-blend ingredient that is prepared as a standalone ingredient prior to combining with the gum base and optional bulk sweetener to form a chewing gum composition.

The flavor pre-blend contains a combination of hydrophilic and lipophilic ingredients combined to form a homogeneous mixture. Exemplary hydrophilic ingredients include sweetener syrups (e.g. corn syrup, maltitol syrup, etc.), particulate sweetener (e.g., particulate sucrose, maltitol, mannitol, etc.), and humectants (e.g. glycerin, etc.). The hydrophilic ingredients are mixed with lipophilic ingredients, such as a fat, an emulsifier (when used), flavorants, etc., to form the flavor pre-blend as a substantially homogeneous mixture. In an embodiment, the flavor pre-blend can be characterized as an emulsion. In an embodiment, the flavor pre-blend also can be characterized as a suspension or dispersion.

Use of the flavor pre-blend in a chewing gum composition provides a chewing gum with good chew and texture characteristics and a good early release of flavor. Not wishing to be bound by theory, but it is theorized that the use of the flavor pre-blend prevents flavorants, sensates, etc., particularly of a hydrophobic nature, present in the flavor pre-blend from getting retained in the gum base, allowing them to be released quicker and more completely. The faster release provides a quick burst of flavor such that the consumer experiences a more intense, up-front flavor, juicier perception (such as when food acid is used) and quicker sweetness profile (such as when high intensity sweetener is used) early in the chew. It is also believed a portion of certain flavor pre-blend ingredients, e.g. the hydrophilic ingredients, are maintained in a dissolved or semi-dissolved state, thus allowing quicker dissolution of these ingredients in the saliva of the mouth when the gum is chewed, thereby accentuating flavor perception. The flavor release is also maintained for a long duration during the chew experience. The flavor experience by the consumer is maintained for five minutes or greater from the initial chew, specifically 10 minutes or greater, and more specifically 15 minutes or greater.

The pre-blend contains a combination of hydrophilic and lipophilic ingredients combined to form a homogeneous mixture. Use of the pre-blend allows for the flexible sourcing of particulate sugar alcohols as the pre-blend can be formulated in a way that reduces or eliminates the crystal morphology and particle size history of any starting particulate sugar alcohol used to prepare the pre-blend. Thus, any particulate sugar alcohol can be used without impacting chewing gum formulations and processing.

As the amount of flavor pre-blend or pre-blend increases in the chewing gum, the crystalline material in the overall chewing gum will be reduced such that it is theorized the chewing gum will have improved sensory profile and smoother texture for increased consumer acceptability. In addition, the preparation of the flavor pre-blend and pre-blend is facile and convenient, requiring no special processing equipment or cooking conditions. The flavor pre-blend and pre-blend can be prepared in a convenient format and pumped to conventional gum forming equipment.

### Flavor Pre-Blend

The chewing gum comprises a flavor pre-blend as an ingredient which imparts various desirable attributes to the chewing gum including improved flavor release, particularly at the earlier chew bites. The term “flavor” as used in “flavor pre-blend” is inclusive of aroma, taste, and mouthfeel.

In an embodiment, a flavor pre-blend comprises i) a saccharide syrup or sugar alcohol syrup, ii) a viscosity enhancing agent that is a protein, a hydrocolloid, talc, a polysaccharide, a polyethylene glycol, or a combination thereof, iii) an emulsifier, iv) a flavorant, and v) a fat. The flavor pre-blend can optionally further comprise vi) a food acid or salt thereof, a high intensity sweetener, a sensate, or a combination thereof. In an embodiment, the flavor pre-blend is free of a particulate sugar alcohol, free of a particulate saccharide, and is not prepared from a particulate sugar alcohol or a particulate saccharide.

In an embodiment, a flavor pre-blend comprises i) a particulate saccharide or particulate sugar alcohol, ii) an amount of humectant sufficient to wet the particulate saccharide or particulate sugar alcohol wherein the humectant is glycerin, propylene glycol, or a combination thereof, iii) an emulsifier, iv) a flavorant, and v) a fat. The flavor pre-blend can optionally further comprise vi) water, a food acid or salt thereof, a high intensity sweetener, a sensate, or a combination thereof. In an embodiment, the flavor pre-blend is free of a sugar alcohol syrup, free of a saccharide syrup, and is not prepared from a sugar alcohol syrup or a saccharide syrup.

In an embodiment, a flavor pre-blend comprises i) a saccharide syrup or sugar alcohol syrup, ii) a particulate saccharide, particulate sugar alcohol, or a combination thereof, iii) a viscosity enhancing agent that is a protein, a hydrocolloid, talc, a polysaccharide, a polyethylene glycol, or a combination thereof, iv) a flavorant, and v) a fat. The flavor pre-blend can optionally further comprise vi) a food acid or salt thereof, a high intensity sweetener, a sensate, or a combination thereof. In an embodiment, the flavor pre-blend is free of an emulsifier and is not prepared from an emulsifier.

In an embodiment, the flavor pre-blend generally comprises a non-crystallizing type syrup such as a saccharide syrup or sugar alcohol syrup; and a particulate saccharide or particulate sugar alcohol. Sugar alcohol is also referred to herein as “polyol”.

In an embodiment, the flavor pre-blend further comprises a food acid or salt thereof, a high intensity sweetener, a sensate, a flavor modulator or potentiator, a coloring agent, a functional ingredient, a humectant, a hydrocolloid, or a combination thereof.

Suitable saccharide syrups include mono-saccharide, di-saccharide and polysaccharide syrups such as but not limited to, syrups prepared from sucrose (sugar), dextrose, maltose, dextrin, xylose, ribose, glucose, mannose, galactose, fructose (levulose), lactose, invert sugar, fructo oligo saccharide, partially hydrolyzed starch, high fructose corn syrup, polydextroses, or a combination thereof.

Exemplary sugar alcohol syrups include a hydrogenated starch hydrolysate syrup, an isomaltulose syrup, a maltitol syrup, a sorbitol syrup, a polyglucitol syrup, or a combination thereof. In an embodiment, the sugar alcohol syrup is a hydrogenated starch hydrolysate syrup, a maltitol syrup, or a combination thereof. In yet another embodiment, the sugar alcohol syrup is a maltitol syrup. Use of more than one sugar alcohol in a dissolved state helps to prohibit re-crystallization of other sugar alcohols present. Exemplary non-crystallizing sugar alcohol syrup includes maltitol solution (Lycasin), hydrogenated starch hydrolysate syrup including polyglucitol syrup which can contain >50% polymers or maltitol and sorbitol <50%, non crystallizing sorbitol solution which contains >5% polymers having a degree of polymerization (DP) of 3, 5, or greater, and the like. Exemplary crystallizing sugar alcohol syrup include a solution prepared from 70% crystalline sorbitol powder and 30% water, a solution prepared from crystalline maltitol dissolved in water, and the like.

The saccharide syrup or sugar alcohol syrup can have about 60 to about 90 weight percent (wt %) dry matter with the remaining weight being water, specifically about 65 to about 85 wt %, and more specifically about 70 to about 75 wt %.

When used to prepare a flavor pre-blend, the amount of sugar alcohol syrup present in the flavor pre-blend is about 5 to about 75 wt % based on the total weight of the flavor pre-blend, specifically about 10 to about 60 wt %, more specifically about 15 to about 50 wt %, yet more specifically about 20 to about 40 wt %, and still yet more specifically about 25 to about 30 wt %.

Particulate saccharide and particulate sugar alcohol as used herein means particulate or powdered saccharide and sugar alcohols, and specifically excludes syrups or solutions. Suitable particulate saccharides include particulate mono-saccharides, di-saccharides and poly-saccharides such as but not limited to, sucrose (sugar), dextrose, maltose, dextrin, xylose, ribose, glucose, mannose, galactose, fructose (levulose), lactose, corn syrup solids, or a combination thereof.

The particulate sugar alcohol of the flavor pre-blend includes a crystalline sugar alcohol, an amorphous sugar alcohol, or a combination thereof. The particulate sugar alcohol can be erythritol, galactitol, isomalt, a hydrogenated starch hydrolysate, lactitol, maltitol, mannitol, polyglycitol, sorbitol, xylitol, or a combination thereof. In an embodiment, the particulate sugar alcohol is erythritol, maltitol, mannitol, sorbitol, xylitol, or a combination thereof. In an embodiment, the particulate sugar alcohol is maltitol, mannitol, sorbitol, or a combination thereof. In an embodiment, the particulate sugar alcohol is mannitol.

In an embodiment, the particulate sugar alcohol can be isomalt, a disaccharide alcohol. Isomalt can be prepared by hydrogenating isomaltulose. Products of the hydrogenation can include 6-O-α-D-glucopyranosyl-D-sorbitol (1,6-GPS); 1-O-α-D-glucopyranosyl-D-sorbitol (1,1-GPS); 1-O-α-D-glucopyranosyl-D-mannitol (1,1-GPM); 6-O-α-D-glucopyranosyl-D-mannitol (1,6-GPM); and mixtures thereof. Some commercially available isomalt materials include an almost equimolar mixture of 1,6-GPS, and 1,1-GPM. Other isomalt materials can include pure 1,6-GPS; 1,1-GPS; 1,6-GP; and 1,1-GPM. Still other isomalt materials can include mixtures of 1,6-GPS; 1,1-GPS; 1,6-GPM; and 1,1-GPM at any ratio.

As used herein “particulate sugar alcohol or particulate saccharide of the flavor pre-blend” means a particulate sugar alcohol or particulate saccharide is used to prepare the flavor pre-blend. The particulate sugar alcohol/saccharide is typically dissolved and/or wetted in the syrup at temperatures between room temperature and 80° C., but below the boiling point of the hydrophilic portion of the flavor pre-blend. The particulate sugar alcohol/saccharide is used to increase the solids (dry matter) content of the syrup to a level of greater than 80 wt % based on the combination of the syrup and particulate, specifically greater than or equal to 82 wt %, more specifically greater than or equal to 85 wt %, and yet more specifically greater than or equal to 87 wt %.

When used to prepare a flavor pre-blend, the amount of particulate sugar alcohol can be about 5 to about 60 wt % based on the total weight of the flavor pre-blend, specifically about 10 to about 50 wt %, more specifically about 15 to about 40 wt %, yet more specifically about 20 to about 30 wt %, and still more specifically about 23 to about 27 wt %.

In an embodiment, the particulate saccharide or particulate sugar alcohol present in the flavor pre-blend has a particle size of 20 micrometers or less average particle size. Small particulates disperse well and increase viscosity of the blend.

The flavor pre-blend used to prepare the chewing gum can comprise a flavorant. Exemplary flavorants (flavor, flavoring agent) that can be used include those artificial or natural flavors known in the art, for example synthetic flavor oils, natural flavoring aromatics and/or oils, oleoresins, extracts derived from plants, leaves, flowers, fruits, and the like, or a combination thereof. Nonlimiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, or a combination thereof. Specific flavorants are mints such as peppermint, spearmint, artificial vanilla, cinnamon derivatives, and various fruit flavors.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin).

The flavorant can be used in liquid or solid form, specifically a liquid form for use in the flavor pre-blend.

More than one flavorant can be used in the flavor pre-blend. The amount and type of flavorant used in the flavor pre-blend can be chosen based on the targeted release profile and flavor intensity desired. The flavor pre-blend generally comprises a flavorant in an amount of about 0 to about 20 wt % based on the total weight of the flavor pre-blend, specifically about 0.01 to about 17 wt %, and yet more specifically about 0.5 to about 12 wt %, still yet more specifically about 1.0 to about 8 wt %, more specifically about 1.75 to about 5 wt %, more specifically about 2.5 to about 4.5 wt %, and even more specifically about 3.5 to about 4 wt %.

Exemplary fats for use in the flavor pre-blend include fats and oils of vegetable origin, animal origin, or a combination thereof. Suitable vegetable fats can include soybean, cottonseed, corn, almond, peanut, sunflower, rapeseed, olive, palm, palm kernel, illipe, shea, coconut, cocoa, cocoa butter, or a combination thereof. The forgoing vegetable fats can be hydrogenated to varying degrees as desired or separated by fractional crystallization. Suitable animal fats include dairy fats such as milk fat and butter. As used herein, the term “fat” refers to any lipid material and can be solid or liquid (e.g. oil). Exemplary lipid materials include triglycerides, fatty alcohols, fatty acids, or a combination thereof. The triglyceride is not limited although medium chain triglycerides, long chain triglycerides, and the like can be used. The melting point of the fat is not limited although fats having a melting point of about 36 to about 68° C. can be used. Specific fats include hydrogenated palm oil, hydrogenated palm kernel oil, hydrogenated soybean oil, hydrogenated peanut oil, hydrogenated cottonseed oil, hydrogenated coconut oil, or a combination thereof.

A fat can be present in the flavor pre-blend in an amount of about 0.1 to about 15 wt % based on the total weight of the flavor pre-blend, specifically about 2.5 to about 10 wt %, more specifically about 5.0 to about 7.5, yet more specifically about 5.5 to about 7.0 wt %, and still yet more specifically about 6.0 to about 6.75 wt %.

In certain embodiments, the flavor pre-blend can also contain an emulsifier. As used herein “emulsifier” means a material that retards the separation of two immiscible liquids after they are mixed. Suitable emulsifiers for use in the flavor pre-blend can have an HLB value in the range of 1 to 22, specifically 11 to 17, and more specifically 4 to 8. Emulsifiers can be selected based on the type of the emulsion. In general, higher HLB emulsifiers that are water soluble/dispersible can be used in the continuous aqueous phase for preparing an oil in water emulsion while lower HLB emulsifiers can be used in the continuous liphphilic phase for preparing water in oil emulsions. Exemplary emulsifiers include distilled monoglycerides, lecithin, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate (glyceryl monostearate), glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, or a combination thereof.

In an embodiment, the emulsifier of the flavor pre-blend is lecithin, glyceryl monostearate, or a combination thereof.

When used, the emulsifier can be present in the flavor pre-blend in an amount of about 0.01 to about 15 wt % based on the total weight of the flavor pre-blend, specifically about 1.0 to about 7.0 wt %, more specifically about 2.5 to about 5.0 wt %, yet more specifically about 2.75 to about 3.5 wt %, and still yet more specifically about 3.0 to about 3.25 wt %.

In certain embodiments, the flavor pre-blend includes a viscosity enhancing agent such as a protein, a hydrocolloid, talc, a polysaccharide, a polyethylene glycol, or a combination thereof. The polyethylene glycol can be a low molecular weight polyethylene glycol (e.g. molecular weight of about 1000 or less). Certain materials can be characterized under one or more of these categories (e.g. gelatin is both a protein and a hydrocolloid).

When used, the viscosity enhancing agent can be present in an amount of about 1.0 to about 40 wt % based on the total weight of the flavor pre-blend, specifically about 5.0 to about 35 wt %, more specifically about 10 to about 30 wt %, yet more specifically about 15 to about 25 wt %, and still more specifically about 18 to about 22 wt %.

The flavor pre-blend may optionally further comprise a hydrocolloid. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Modified natural gums include propylene glycol alginate, carboxymethyl locust bean gum, low methoxyl pectin, or a combination thereof. Modified celluloses can be included such as microcrystalline cellulose, carboxymethlcellulose (CMC), methylcellulose (MC), hydroxypropylmethylcellulose (HPMC), hydroxypropylcellulose (MPC), or a combination thereof. In an embodiment, the hydrocolloid is gelatin.

The flavor pre-blend can contain the hydrocolloid in an amount to improve viscosity and stability of the blend. Exemplary amounts of hydrocolloid can be about 1.0 to about 40 wt % based on the total weight of the flavor pre-blend, specifically about 5.0 to about 35 wt %, more specifically about 10 to about 30 wt %, yet more specifically about 15 to about 25 wt %, and still more specifically about 18 to about 22 wt %.

The flavor pre-blend may optionally further comprise a humectant. Exemplary humectants include glycerin, propylene glycol, or a combination thereof. The humectant can be added to retard the loss of moisture and to retard crystallization of the particulate sweetener. The use of a humectant can increase the liquidity of the flavor pre-blend without adding moisture to the blend.

In the flavor pre-blend embodiment comprising a saccharide syrup, a sugar alcohol syrup, or a combination thereof, the humectant can be present in an amount of about of about 0.1 to about 30 wt % based on the total weight of the flavor pre-blend, specifically about 2.5 to about 20 wt %, more specifically about 4.0 to about 15 wt %, yet more specifically about 5.0 to about 10 wt %, and still yet more specifically about 6.0 to about 9.0 wt %. In the flavor pre-blend embodiment free of a saccharide syrup, a sugar alcohol syrup, or a combination thereof, the humectant can be present in an amount of about of about 10 to about 75 wt % based on the total weight of the flavor pre-blend, specifically about 15 to about 65 wt %, more specifically about 20 to about 55 wt %, yet more specifically about 20 to about 45 wt %, and still yet more specifically about 25 to about 35 wt %.

The flavor pre-blend may optionally further comprise a food acid or salt thereof. Exemplary food acids and food acid salts for use in the flavor pre-blend include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and alkali metal salts thereof (e.g., sodium citrate dihydrate), or a combination thereof. In an embodiment, the food acid is citric acid, malic acid, tartaric acid or a combination thereof.

The flavor pre-blend can optionally further comprise a sensate. Exemplary sensates include cooling agents, warming agents, tingling agents, effervescent agents, or a combination thereof. Coolants are additives that provide a cooling or refreshing effect in the mouth, in the nasal cavity, or on skin. For example, among the useful cooling agents are included menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-2,2-diisopropylbutanamide, N-ethyl-p-menthane-3-carboxamide (WS-3), ethyl ester of N-[[5-methyl-2-(1-methylethyl)cyclohexyl]carbonyl]glycine (WS-5), as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference, isopulegol, menthyloxy propane diol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, N-(4-cyanomethylphenyl) p-menthanecarboxamide (G-180), Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; Menthol methyl ether, menthyl pyrrolidone carboxylate; 2,5-dimethyl-4-(1-pyrrolidinyl)-3(2H)-furanone; cyclic α-keto enamines, cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one, compounds of the formula:

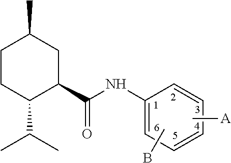

wherein B is selected from H, CH₃, C₂H₅, OCH₃, OC₂H₅; and OH; and wherein A is a moiety of the formula-CO-D, wherein D is selected from the following moieties: (i) —NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five- or six-membered heterocyclic ring; (ii) —NHCH₂COOCH₂CH₃, —NHCH₂CONH₂, —NHCH₂CH₂OCH₃, —NHCH₂CH₂OH, —NHCH₂CH(OH)CH₂OH and (iii) a moiety such as:

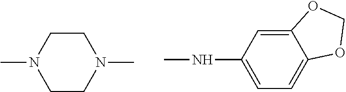

as disclosed in PCT Patent Application WO2006/125334 to Bell et al. which is incorporated in its entirety herein by reference, among others; or a combination thereof. Other compounds include the alpha-keto enamines disclosed in U.S. Pat. No. 6,592,884 to Hofmann et al. which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Published patent applications, all of which are incorporated in their entirety by reference hereto: U.S. 2005/0222256; 2005/0265930.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming agents included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropol alcohol, iso-amylalcohol, benzyl alcohol, glycerine, or a combination thereof.

In an embodiment, tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (piper nigrum), including the active ingredients chavicine and piperine; Echinacea extract; Northern Prickly Ash extract; trans-pellitorin, and red pepper oleoresin; or a combination thereof. In an embodiment, alkylamides extracted from materials such as jambu or sanshool may be included. Additionally, in an embodiment, a sensation is created due to effervescence. Such effervescence is created by combining an alkaline material with an acidic material, either or both of which may be encapsulated. In an embodiment, an alkaline material may include alkali metal carbonates, alkali metal bicarbonates, alkaline earth metal carbonates, alkaline earth metal bicarbonates or a combination thereof. In an embodiment, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid or a combination thereof. Examples of “tingling” type sensates include those disclosed in U.S. Pat. Nos. 6,780,443, 6,159,509, 5,545,424, and 5,407,665, each of which is incorporated by reference herein in its entirety.

The flavor pre-blend can optionally further comprise a flavor modulator, potentiator, or a combination thereof. A sweet taste can come from flavor modulators or potentiators and/or from flavorants as well as from sweeteners. Flavor potentiators can consist of materials that intensify, supplement, modify or enhance the taste or aroma perception of an original material without introducing a characteristic taste or aroma perception of their own. Flavor modulators can impart a characteristic of their own that complements or negates a characteristic of another component. In an embodiment, flavor modulators or potentiators are designed to intensify, supplement, modify, or enhance the perception of flavor, sweetness, tartness, umami, kokumi, saltiness or a combination thereof can be included. Thus, the addition of flavor modulators or potentiators can impact the overall taste of the chewing gum. For example, flavors can be compounded to have additional sweet notes by the inclusion of flavor modulators or potentiators, such as vanilla, vanillin, ethyl maltol, furfual, ethyl propionate, lactones, or a combination thereof.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), or a combination thereof. In an embodiment, sugar acids, sodium chloride, potassium chloride, sodium acid sulfate, or a combination thereof are used. In an embodiment, glutamates such as monosodium glutamate, monopotassium glutamate, hydrolyzed vegetable protein, hydrolyzed animal protein, yeast extract, or a combination thereof are included. Further examples include adenosine monophosphate (AMP), glutathione, and nucleotides such as inosine monophosphate, disodium inosinate, xanthosine monophosphate, guanylate monophosphate, or a combination thereof. Further examples of flavor potentiator compositions that impart kokumi are also included in U.S. Pat. No. 5,679,397 to Kuroda et al.

The amount of flavor modulators and flavor potentiators used herein can be a matter of preference subject to such factors as the type of final product composition, the individual flavor, and the strength of flavor desired. Thus, the amount of flavoring can be varied in order to obtain the result desired in the final product and such variations are within the capabilities of those skilled in the art without the need for undue experimentation.

Exemplary functional ingredients for use in the flavor pre-blend include a breath freshener, a dental care component, an active, an herbal, an effervescing system, an appetite suppressor, a vitamin, a micronutrient, a mouth moistening component, a throat care component, an energy boosting agent, a concentration boosting agent, or a combination thereof.

The flavor pre-blend may optionally further comprise a high intensity sweetener. A “high intensity sweetener” as used herein means agents having a sweetness greater than the sweetness of sucrose. In an embodiment, a high intensity sweetener has a sweetness that is at least 100 times that of sugar (sucrose) on a per weight basis, specifically at least 500 times that of sugar on a per weight basis. In an embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, or a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, or a combination thereof;

water-soluble sweeteners derived from naturally occurring water-soluble sweeteners, such as steviosides and stevia derived compounds such as but not limited to steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galactopyranosyl-1,6-dichloro-1,6-dideoxy-beta-D-fructofuranoside, or 4,6,1′,6′-tetrachloro4,6,1′,6′-tetradeoxygalacto-sucrose; 4,6,1′,6′-tetradeoxy-sucrose, or a combination thereof;

protein based sweeteners such as thaumaoccous danielli, talin, or a combination thereof; and

amino acid based sweeteners.

The flavor pre-blend may optionally further comprise a color. Coloring agents (colors, colorants, colorings) can be used in amounts effective to produce a desired color for the flavor pre-blend and ultimately the chewing gum. Suitable coloring agents include pigments, which can be incorporated in amounts up to about 6 wt % based on the total weight of the chewing gum. For example, titanium dioxide can be incorporated in amounts up to about 2 wt %, and specifically less than about 1 wt % based on the total weight of the chewing gum. Suitable coloring agents also include natural food colors and dyes suitable for food, drug, and cosmetic applications. Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), or a combination thereof. In an embodiment, certified colors can include FD&C aluminum lakes, or a combination thereof. A full recitation of all FD& C colorants and their corresponding chemical structures may be found in the Kirk-Othmer Encyclopedia of Chemical Technology, 4th Edition, in volume 1 at pages 492-494, which text is incorporated herein by reference.

Coloring agents can also include food grade glitter which can be incorporated into the flavor pre-blend. The edible glitter can include a food grade colorant and a carrier such as a sugar, a sugar alcohol, a disaccharide, a polysaccharide, a hydrocolloid material, or a combination thereof. Exemplary glitter includes the commercially available Edible Glitter™ from Watson Inc. of West Haven, Conn.

The coloring agent can include food grade pearlescent pigments prepared from mica optionally coated with titanium dioxide, iron oxide, and the like.

In an embodiment, flavor pre-blend does not comprise added water. As used herein “added water” means water added as a discrete ingredient. Added water excludes the water present in the saccharide syrups or sugar alcohol syrups, if used. In an embodiment, the flavor pre-blend has a moisture content of about 5 to about 10 wt % of the total flavor pre-blend, specifically about 6 to about 9, more specifically about 7 to about 8.5, and yet more specifically about 7.5 to about 8.

In an embodiment, the flavor pre-blend comprises hydrophilic ingredients in the form of a discrete phase and lipophilic ingredients in the form of a continuous phase.

### Pre-Blend Ingredient

The chewing gum can comprise a pre-blend as an ingredient which also imparts various desirable attributes to the chewing gum including better ingredient release, particularly at the earlier chew bites. Additionally, the pre-blend can be formulated in a way that reduces or eliminates the crystal morphology and particle size history of any starting particulate saccharide or particulate sugar alcohol used to prepare the pre-blend. Thus, any particulate saccharide or particulate sugar alcohol can be used without impacting chewing gum formulations and processing.

In an embodiment, the pre-blend is prepared from i) a sugar alcohol derived from a particulate sugar alcohol, specifically particulate sorbitol, ii) a saccharide syrup or sugar alcohol syrup, iii) an emulsifier, iv) a fat, and optionally v) a flavorant, a humectant, a food acid or salt thereof, a high intensity sweetener, a sensate, an inorganic powder, or a combination thereof; wherein the pre-blend is prepared prior to combining with a composition comprising a gum base to form a chewing gum composition.

In an embodiment, the pre-blend is prepared from i) a sugar alcohol derived from a particulate sugar alcohol, specifically particulate sorbitol, ii) a saccharide syrup or sugar alcohol syrup, iii) an emulsifier, iv) a fat, v) a humectant that is glycerin, propylene glycol, or a combination thereof, and optionally vi) a flavorant, a food acid or salt thereof, a high intensity sweetener, a sensate, an inorganic powder, or a combination thereof; wherein the pre-blend is prepared prior to combining with a composition comprising a gum base to form a chewing gum composition.

In an embodiment, the pre-blend is a viscous liquid having little to no crystalline sugar alcohol present after the pre-blend is prepared.

In an embodiment, the particulate sugar alcohol of the pre-blend is wetted or dissolved by the saccharide syrup, sugar alcohol syrup, or a combination thereof.

In an embodiment, the pre-blend comprises about 4 to about 10 wt % moisture based on the total weight of the pre-blend, specifically about 5 to about 9 wt %, more specifically about 6 to about 8 wt %, and still yet more specifically about 6.5 to about 7.5 wt %.

“A sugar alcohol derived from a particulate sugar alcohol” means the pre-blend is prepared from a particulate sugar alcohol where the particulate sugar alcohol is wetted or dissolved. The particulate sugar alcohol for use to prepare the pre-blend can be any one as used for the flavor pre-blend above, specifically particulate sorbitol. The particulate sugar alcohol can be present in the pre-blend in an amount of about 5 to about 60 wt % based on the total weight of the pre-blend, specifically about 10 to about 50 wt %, more specifically about 15 to about 40 wt %, yet more specifically about 20 to about 35 wt %, and still more specifically about 25 to about 30 wt %.

The saccharide syrup or sugar alcohol syrup for use to prepare the pre-blend can be any one as used for the flavor pre-blend above, specifically a non-crystallizing syrup and is used in an amount sufficient to wet the particulate sugar alcohol. The saccharide syrup or sugar alcohol syrup can be present in the pre-blend in an amount of about 5 to about 75 wt % based on the total weight of the pre-blend, specifically about 10 to about 60 wt %, more specifically about 15 to about 50 wt %, yet more specifically about 20 to about 40 wt %, and still yet more specifically about 25 to about 30 wt %.

The emulsifier for use to prepare the pre-blend can be any one as used for the flavor pre-blend above. The emulsifier can be present in the pre-blend in an amount of about 0.01 to about 15 wt % based on the total weight of the pre-blend, specifically about 0.1 to about 10 wt %, more specifically about 1.0 to about 7.0 wt %, yet more specifically about 2.0 to about 5.0 wt %, and still yet more specifically about 3.0 to about 4.0 wt %.

The fat for use to prepare the pre-blend can be any one as used for the flavor pre-blend above. The fat can be present in the pre-blend in an amount of about 0.1 to about 15 wt % based on the total weight of the pre-blend, specifically about 1.0 to about 10 wt %, more specifically about 2.0 to about 8.0, yet more specifically about 3.0 to about 7.0 wt %, and still yet more specifically about 4.0 to about 6.0 wt %.

The flavorant for use to prepare the pre-blend can be any one as used for the flavor pre-blend above. The flavorant can be present in the pre-blend in an amount of about 0 to about 20 wt % based on the total weight of the pre-blend, specifically about 0.01 to about 17 wt %, and yet more specifically about 0.5 to about 12 wt %, still yet more specifically about 1.0 to about 8 wt %, more specifically about 1.75 to about 5 wt %, more specifically about 2.5 to about 4.5 wt %, and even more specifically about 3.5 to about 4 wt %.

The humectant for use to prepare the pre-blend can be any one as used for the flavor pre-blend above. The humectant can be present in the pre-blend in an amount of about 0.1 to about 30 wt % based on the total weight of the pre-blend, specifically about 2.5 to about 20 wt %, more specifically about 4.0 to about 15 wt %, yet more specifically about 5.0 to about 10 wt %, and still yet more specifically about 6.0 to about 9.0 wt %.

In an embodiment, the pre-blend further comprises a food acid or salt thereof, a high intensity sweetener, a sensate, an inorganic powder, a flavor modulator or potentiator, a coloring agent, a functional ingredient, a hydrocolloid, a viscosity enhancing agent, or a combination thereof. These can include any of those materials described above for use in the flavor pre-blend.

When used, the hydrocolloid can be present in the pre-blend in an amount of about 0.1 to about 20 wt % based on the total weight of the pre-blend, specifically about 1.0 to about 15 wt %, more specifically about 2.0 to about 10 wt %, and yet more specifically about 4.5 to about 8.0 wt %.

When used, the viscosity enhancing agent can be present in the pre-blend in an amount of about 0.1 to about 20 wt % based on the total weight of the pre-blend, specifically about 1.0 to about 15 wt %, more specifically about 2.0 to about 10 wt %, and yet more specifically about 4.5 to about 8.0 wt %.

### Methods of Making the Flavor Pre-Blend or Pre-Blend

The flavor pre-blend or pre-blend is typically prepared by blending the flavor pre-blend or pre-blend ingredients together with optional gentle heating or high shear to effect dissolution of the blend ingredients. In an embodiment, the flavor pre-blend or pre-blend ingredients are combined in no particular order. The flavor pre-blend or pre-blend is not cooked or boiled nor is heat, vacuum, and/or coevaporation used to drive off or remove water from the blend during the process to make the pre-blend. In an embodiment, external heat is not added. In another embodiment, high shear is used to prepare the flavor pre-blend or pre-blend. In another embodiment, the flavor pre-blend or pre-blend is prepared by micronizing.

In an embodiment, the flavor pre-blend or pre-blend is prepared by combining the hydrophobic ingredients (e.g. fat, emulsifier) together with mixing and optional heating. The temperature used to heat is less than or equal to 85° C., specifically about 40 to about 80, more specifically about 50 to about 75, and yet more specifically about 60 to about 70° C. Separately, the hydrophilic ingredients (e.g. particulate sugar alcohol, sugar alcohol syrup) are mixed together. Again, to hasten the dissolution of the ingredients, the mixture can be warmed to less than or equal to 85° C., specifically about 40 to about 80° C., more specifically about 50 to about 75° C., and yet more specifically about 60 to about 70° C. The hydrophobic ingredients mixture is then mixed with the hydrophilic ingredients mixture with optional heating until a homogeneous mixture is formed. Optionally, extra shear can be applied in the mixing process to force dissolution. Any type of equipment can be used to prepare the mixture. Exemplary equipment includes propeller mixers and homogenizers, and the like. The mixture is then cooled to about 35 to about 60° C., specifically about 40 to about 55° C. and flavorant and other optional ingredients (e.g. food acid, sensate, etc.) are added to the mixture with mixing to form the flavor pre-blend or pre-blend.

In an embodiment, the preparation of the flavor pre-blend or pre-blend is conducted entirely at a temperature less than or equal to 85° C., specifically less than or equal to about 80° C., and still more specifically less than or equal to about 75° C.

### Chewing Gum Composition

In general the chewing gum comprises a composition comprising a gum base and an optional bulk sweetener; and a flavor pre-blend or pre-blend as described above. When used, the bulk sweetener of the chewing gum, independent of the ingredients of the gum base and flavor pre-blend or pre-blend, can be a sugar-based or sugar-free bulk sweetener, specifically sugar-free. In an embodiment, the chewing gum comprises a pre-blend and is free of bulk sweeteners, specifically free of particulate sweeteners such as particulate sugar alcohols, rather all of the sweetener or sugar alcohol is derived from the pre-blend.

In an embodiment, the chewing gum comprises two or more flavor pre-blends, two or more pre-blends, a flavor pre-blend and a pre-blend, or combinations thereof.

The amount of flavor pre-blend present in the chewing gum composition can be about 1 to about 70 wt % based on the total weight of the chewing gum, specifically about 5 to about 60 wt %, more specifically about 10 to about 50, yet more specifically about 15 to about 40 wt %, and still yet more specifically about 20 to about 30 wt %.

The amount of pre-blend present in the chewing gum composition can be about 1 to about 70 wt % based on the total weight of the chewing gum, specifically about 5 to about 60 wt %, more specifically about 10 to about 50, yet more specifically about 15 to about 40 wt %, and still yet more specifically about 20 to about 30 wt %.

Bulk sugar sweeteners generally include saccharides. Suitable sugar sweeteners include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, or a combination thereof.

In an embodiment, the bulk sweetener comprises a sugar alcohol. The sugar alcohol can be erythritol, galactitol, isomalt, a hydrogenated starch hydrolyzate, lactitol, maltitol, mannitol, polyglycitol, sorbitol, xylitol, and the like, or a combination thereof.

The amount of bulk sweetener, when present, in the chewing gum composition can be about 1.0 to about 85 wt % based on the total weight of the chewing gum, specifically about 5.0 to about 75 wt %, more specifically about 10 to about 65 wt %, yet more specifically about 20 to about 55 wt %, and yet more specifically about 30 to about 45 wt %, the forgoing amounts are independent of any bulk sweetener used in the flavor pre-blend or pre-blend.

In an embodiment, the chewing gum does not contain a bulk sweetener other than the saccharide or sugar polyol of the pre-blend.

The amount of gum base employed will vary greatly depending upon various factors such as the type of base used, the consistency of the chewing gum desired, piece weight, desired bolus size, and the other components used in the composition to make the final chewing gum. In general, the gum base will be present in amounts of about 5.0 to about 70 wt % based on the total weight of the chewing gum, specifically about 10 to about 50 wt %, more specifically about 20 to about 40 wt %, and yet more specifically about 25 to about 35 wt %.

The chewing gum may further comprise an additional ingredient wherein the additional ingredient is a food acid or salt thereof, a high intensity sweetener, a sensate, a flavorant, a flavor modulator or potentiator, a coloring agent, a functional ingredient, a hydrocolloid, or a combination thereof. The foregoing additional ingredients are in addition to the food acid or salt thereof, high intensity sweetener, sensate, flavorant, flavor modulator or potentiator, coloring agent, and/or functional ingredient which may be present in the flavor pre-blend or pre-blend.

Exemplary additional food acid or salt thereof for use in the chewing gum can include those described above for use in the flavor pre-blend or pre-blend. The additional food acid or salt thereof may be used in free form or in an encapsulated form.

Exemplary additional high intensity sweetener for use in the chewing gum can include those described above for use in the flavor pre-blend or pre-blend. Furthermore, the additional high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, or a combination thereof.

Exemplary additional sensate for use in the chewing gum can include those described above for use in the flavor pre-blend or pre-blend. The additional sensate may be used in free form or in an encapsulated form.

Exemplary additional flavorant for use in the chewing gum can be those described above for use in the flavor pre-blend or pre-blend. The flavorant can be used in liquid or solid form. When used in solid (dry) form, suitable drying means such as spray drying the oil can be used. Alternatively, the flavorant can be encapsulated, absorbed onto water soluble materials by means known in the art, for example cellulose, starch, sugar, maltodextrin, gum arabic, and the like. In an embodiment, the flavorant can be used in physical forms effective to provide an initial burst of flavor or a prolonged sensation of flavor.

Exemplary additional flavor modulator or potentiator, additional coloring agent, and additional functional ingredient for use in the chewing gum includes those previously described above for use in the flavor pre-blend or pre-blend.

The amount of additional food acid or salt thereof, additional flavorant, additional sensate, additional coloring agent, additional flavor modulator or potentiator, additional functional agent, or a combination thereof present in the chewing gum can be up to about 5.0 wt % for each individual ingredient based on the total weight of the chewing gum composition, specifically about 1.0 to about 4.0 wt %, and more specifically about 2.0 to about 3.0 wt %.

The chewing gum may comprise a hydrocolloid as an additional ingredient. Exemplary hydrocolloids include those described above including pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums; modified natural gums such as propylene glycol alginate, carboxymethyl locust bean gum, and low methoxyl pectin; modified celluloses such as microcrystalline cellulose, carboxymethlcellulose (CMC), methylcellulose (MC), hydroxypropylmethylcellulose (HPMC), and hydroxypropylcellulose (MPC); or a combination thereof.

In an embodiment, the chewing gum composition further comprises inclusions. The inclusions can be large particles of sugar alcohol, saccharide, or a confectionery such as a chewy candy, a crunchy candy, a low boiled candy, a hard boiled, a fondant, a caramel, a jelly, a gummy, a nougat, a fruit leather, a nut paste, chocolate, fudge, or a combination thereof. Generally, the inclusion can have an average particle size of about 0.35 to about 5 mm.

### Gum Base

The chewing gum further comprises a chewing gum base. In an embodiment, the chewing gum comprises a gum base comprising an elastomer; a fat; an emulsifier; and optionally an additional gum base ingredient, wherein the additional gum base ingredient is a wax, a filler, an antioxidant, or a combination thereof.

As used herein, the term “gum base” refers to water insoluble material(s) and can include, but is not limited to, elastomers, bulking agents, waxes, elastomer solvents, emulsifiers, plasticizers, fillers, or a combination thereof.

Exemplary elastomers to be used in the chewing gum base include both natural and synthetic elastomers and rubbers, for example, substances of vegetable origin such as chicle, crown gum, nispero, rosadinha, jelutong, perillo, niger gutta, tunu, balata, gutta-percha, lechi-capsi, sorva, gutta kay, and the like, or a combination thereof. Synthetic elastomers such as butadiene-styrene copolymers, polyisobutylene, isobutyleneisoprene copolymers, polyethylene, a combination thereof, and the like, or a combination thereof are also useful. The gum base can include a non-toxic vinyl polymer, such as polyvinyl acetate and its partial hydrolysate, polyvinyl alcohol, or a combination thereof. When utilized, the molecular weight of the vinyl polymer can range from about 3,000 up to and including about 94,000 or higher. Additional useful polymers include: crosslinked polyvinyl pyrrolidone, polymethylmethacrylate; copolymers of lactic acid, polyhydroxyalkanoates, plasticized ethylcellulose, polyvinyl acetatephthalate, or a combination thereof.

Conventional additives can be included in the gum base in effective amounts such as plasticizers or softeners to provide a variety of desirable textures and consistency properties. Because of the low molecular weight of these components, the plasticizers and softeners are able to penetrate the fundamental structure of the gum base making it plastic and less viscous. Suitable plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerin, or a combination thereof. Some of these ingredients may be added at the time of gum base formation or added later during the production of the chewing gum composition.

Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, and the like, or a combination thereof, can also be incorporated into the gum base to obtain a variety of desirable textures and consistency properties.

When a wax is present in the gum base, it softens the polymeric elastomer mixture and improves the elasticity of the gum base. The waxes employed may have a melting point below about 60° C., and specifically between about 45° C. and about 55° C. The low melting wax can be a paraffin wax. The wax can be present in the gum base in an amount of about 6 to about 10 wt %, and specifically about 7 to about 9.5 wt % based on the total weight of the gum base.

In addition to the low melting point waxes, waxes having a higher melting point can be used in the gum base in amounts up to about 5 wt % based on the total weight of the gum base. Such high melting waxes include beeswax, vegetable wax, candelilla wax, carnuba wax, most petroleum waxes, and the like, or a combination thereof.

The chewing gum or gum base can optionally contain conventional elastomer solvents to aid in softening the elastomer base component, for example trepanned resins such as polymers of alpha-pinene or beta-pinene; methyl, glycerol or pentaerythritol esters of rosins or modified rosins and gums, such as hydrogenated, dimerized or polymerized rosins, or a combination thereof; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like; or a combination thereof. The elastomer solvent can be used in amounts of about 5 to about 75 wt % base on the total weight of the gum base, and specifically about 45 to about 70 wt %.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, tricalcium phosphate and the like, or a combination thereof. These fillers or adjuvants can be used in the gum base in various amounts. Specifically the amount of filler, when used, can be present in an amount of greater than about 0 to about 60 wt % based on the total weight of the gum base, and more specifically from about 20 to about 30 wt %.

Suitable emulsifiers for use in the gum base include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glycerly dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, tweens, spans, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, or a combination thereof.

### Methods of Making the Chewing Gum Composition

The chewing gum composition can be prepared using standard techniques and equipment. In an embodiment, the flavor pre-blend or pre-blend is added at the end of the chewing gum ingredients mixing process and mixed enough to form a homogenous mass. However, the processes described herein are not necessarily limited to addition of the flavor pre-blend or pre-blend at the end of the mixing process and it can be added at any desired stage of the chewing gum manufacturing process. In an embodiment, the flavor pre-blend or pre-blend is added to a mixer and then molten gum base is added to the mixer so that the blend rapidly attains the process temperature, optionally with or without external cooling. In an embodiment, the chewing gum comprises microscopic regions of flavor pre-blend or pre-blend within the chewing gum matrix.

In one exemplary process, a gum base is heated to a temperature sufficiently high to soften the base without adversely affecting the physical and chemical make up of the base, which will vary depending upon the composition of the gum base used, and is readily determined by those skilled in the art without undue experimentation. For example, the gum base can be conventionally melted to about 60° C. to about 160° C., or melted to about 150° C. to about 175° C., for a period of time sufficient to render the base molten, e.g., about thirty minutes, just prior to being admixed incrementally with the remaining ingredients of the base such as the plasticizer, fillers, and softener to plasticize the blend as well as to modulate the hardness, viscoelasticity and formability of the base, optional chewing gum ingredients are next blended with the gum base to form a composition comprising a gum base, with the flavor pre-blend or pre-blend being added at the end of the process. Mixing is continued until a uniform or homogeneous mixture of the chewing gum composition is obtained. Thereafter the chewing gum composition can be formed into a desired shape.

In another exemplary process, chewing gum ingredients are mixed with gum base, with the flavor pre-blend or pre-blend being added at the end of the process. Mixing is continued until a uniform or homogeneous mixture of the chewing gum composition is obtained. Thereafter the chewing gum composition can be formed into a desired shape. Within this embodiment, the starting gum base can be in an unmolten form, such as in the form of a pelletized gum base, that can be softened at 40 to 50° C. rather than melting at higher temperatures as in the prior embodiment.

The chewing gum composition can be prepared using a batch method or a continuous method or a combination thereof.

The processing equipment used to prepare the chewing gum composition can be monitored and/or controlled automatically. For example, the processing equipment can be coupled to a computerized system which allows the user to input certain and/or all of the operational parameters, including, e.g., feeding of the ingredients, mixing or processing the ingredients, conveying the ingredients. In an embodiment, the system can be coupled to batch processing equipment, continuous processing equipment, or both if both types are used. In an embodiment, changing the input parameters used to control the processing can create changes in the final composition, e.g., ingredient amount and type, etc. For example, the ingredient and/or processing temperatures and/or feed rates of the ingredients can be monitored and fed back to a central unit so that the operator can adjust as needed and/or in which the system can automatically adjust. After the ingredients have been mixed, the formation, processing into a particular shape and/or form can also be monitored and fed back for the operators input and/or automatic adjustment. An audible and/or visual alarm can also be implemented to signal the operator when the system detects a problem and/or a variation in one or more processing parameters.

The chewing gum composition can be formed using a variety of processes including an extrusion process, a coextrusion process, a triple extrusion process, a laminate process, a molding process, a compression process, a rolling and scoring process, a chain die process, a rotary die process, or a cut and wrap process.

The chewing gum composition can be shaped using devices and techniques that are known in the confectionery art. For example, the chewing gum composition can be shaped by hand, with molds and/or dies, cutters, pullers, stretchers, extruders and the like. Non-limiting examples of molds that can be used include, flexible (e.g., made of silicone), metal, plastic, glass, and the packaging itself (e.g., by placing the unshaped mass into the pack), such as a blister pack. Combinations of these may also be employed.

The chewing gum composition can be prepared into discrete units in the form of slabs, sticks, pellets, balls, cubes, and the like. The formation into discrete units can be achieved using a chain die, or rolling and scoring process.

There is no limitation to the size of the discrete unit of the chewing gum composition. In an embodiment, each discrete unit is about 1.5 to about 3.0 grams, specifically about 1.8 to about 2.7 grams, and more specifically about 2.3 to about 2.5 grams as a pellet, slab, or stick format.

The chewing gum can be packaged using techniques and equipment known in the art. For example gum stick packaging, packaging tins, blister trays, and the like can be used. In an embodiment is a packaged product that includes a chewing gum wherein the package has indicia on an outer surface that is indicative of the product contained in the package.

### Other Formats

In an embodiment, the chewing gum composition is formulated into pieces and surface treated using materials and techniques known in the art. Exemplary surface treatments include panned coating (hard or soft), particulate coating (e.g., sanding, dusting, etc.), and treatment with oil optionally including flavors.

As used herein, “soft panned” coatings refer to coatings that provide a soft bite as measured by sensory testing methods. As used herein, “hard panned” coatings refer to coatings that provide a hard or crunchy or crispy bite as measured by sensory testing methods. The chewing gum products may be tested by a fully-trained descriptive analysis panel using various methods, for example, the analysis may be conducted using the Spectrum™ method. This method incorporates a trained panel of individuals who measure chewing gum products for several characteristics, providing a rating for each characteristic. The hardness of the coating may be measured on any scale desired. For example, hardness may be on a ten point scale from 1-10, where a rating of 1 is the softest and a rating of 10 is the hardest. Typically, soft panned coatings have a hardness rating below the rating of hard panned coatings. For example, in an embodiment, a soft panned coated product may have a hardness sensory rating of about 3-4, while hard panned coated product may have a hardness sensory rating of about 7-8.

The uncoated chewing gum pieces (alternatively described as “cores”) can be panned according to conventional processes to create a soft- or hard-panned layers. Conventional techniques for hard and soft panning technology are described in the following: “Sugarless Hard Panning”, Robert Boutin, et al., The Manufacturing Confectioner, pp. 35-42, November 2004; “Panning Technology, An Overview:”, John Flanyak, The Manufacturing Confectioner, pp. 65-74, January 1998; “Crystallization and Drying During Hard Panning”, Richard W, Hartel, The Manufacturing Confectioner, pp. 51-57, February, 1995; “Soft Panning”, Michael J. Lynch, The Manufacturing Confectioner, pp. 47-50, November 1987; and “Panning—The Specialist's Specialty”, Robert D. Walter, Candy & Snack Industry, pp. 43-51, December 1974. Each of these publications is incorporated herein by reference.

The coating composition at least partially surrounding the chewing gum core generally comprises a bulk sweetener and gum arabic, starch or a combination of gum arabic and starch. The coating composition optionally may further comprise an additional ingredient such as a color, a flavorant, a sensate, a food acid or salt thereof, a flavor modulator or potentiator, a functional ingredient, or a combination thereof. Each of these ingredients has been previously described herein. In an embodiment, the additional ingredient is encapsulated or unencapsulated (or “free”). If more than one ingredient is used, the coating may contain any combination of encapsulated or unencapsulated ingredients.

As used herein, the terms “coating” or “coating region” are used to refer to a region of a material that at least partially surrounds the chewing gum core.

As used herein, the terms “surround”, “surrounding”, “at least partially surrounding”, and the like are not limited to encircling. These terms may refer to enclosing or confining on all sides, encircling or enveloping, and are not limited to symmetrical or identical thicknesses.

As used herein, the term “substantially covers” and “substantially surrounding” refers to coating compositions that cover more than 50% of the surface area of a chewing gum core. In an embodiment, “substantially covers” may refer to coverage that is more than 55%, more than 60%, more than 65%, more than 70%, more than 75%, more than 80%, more than 85%, more than 90%, more than 95%, more than 98%, and more than 99% of the surface of a chewing gum core.

The particulate coating can include a powdered sugar, a particulate sugar alcohol, and the like. The particulate layer can be applied by any method known in the art including dusting where electrostatic forces adhere the particulate layer to the chewing gum core or sanding where a binder such as water or syrup helps to adhere the particulates to the chewing gum core.

The coating may be present in an amount from about 2 to about 60 wt %, specifically about 10 to about 45 wt %, and yet more specifically about 25 to about 30 wt % based on the total weight of the coated chewing gum.

The chewing gum may further comprise a center-fill including liquid, semi-solid, solid (including powder), center-fill material. The center-filled chewing gum may be formed by any technique known in the art for forming center-filled confectionery. The method may generally include first extruding a center-filled rope of a chewing gum composition and passing the rope through a sizing mechanism including a series of pairs of pulley-shaped roller members. The roller members “size” the rope or strand of gum material such that it leaves the series of rollers with the desired size and shape for entering a piece-forming mechanism. The flavor pre-blend or pre-blend is not a center-fill component of the chewing gum composition since it is blended with a composition comprising gum base as discussed above.

The chewing gum may be prepared in the form of a layered product comprising a layer of chewing gum composition comprising the flavor pre-blend or pre-blend, or multiple layers of chewing gum composition comprising the flavor pre-blend or pre-blend. In a multilayered product, at least one layer comprises a chewing gum composition comprising a flavor pre-blend or pre-blend while the remaining layers can be an additional chewing gum composition or a confectionery. The layered product can be in any format including a sandwich format with each layer visible on at least 2 sides, specifically at least 4 sides of the product, jelly roll format, and the like. The layered product can be prepared by a coextrusion process, a triple extrusion process, a laminate process, a molding process, a compression process, a rolling and scoring process, a chain die process, a rotary die process, or a cut and wrap process.

The chewing gum may further comprise printed indicia on the surface, either as abstract images (e.g., swirls, lines, dots, and the like), concrete images (e.g. flowers, animals, automobiles, and the like), letters, text, logos, characters, words, symbols, pictures, or a combination thereof, and the like, using colored inks. The printed indicia can be applied using either contact or non-contact techniques. Exemplary contact techniques include gravure printing. Exemplary non-contact techniques include ink-jet printing. In one embodiment, the chewing gum has printed indicia on two or more surfaces.

There is no limitation on the type of color used to prepare the printed indicia as long as it is food safe. More than one color can be used. Additionally, the color of the chewing gum composition can be matched to the color of the printed indicia for a color on color effect. The color of the chewing gum composition and the printed indicia can be selected to provide increased contrast. Vibrant colors can be selected for consumer appeal. The color of the printed indicia can also be matched with the flavor of the chewing gum composition, for example a green printed image for a spearmint chewing gum, a blue printed image for a peppermint chewing gum, a red printed image for a red fruit flavored chewing gum, and the like. Additionally, the colorant composition can further comprise a flavorant.

The chewing gum comprising printed indicia on the surface can be a chewing gum product in the form of a sheet, discrete chewing gum piece, or a set of chewing gum pieces. The set of chewing gum pieces, when placed adjacent to one another, can comprise printed indicia that make up an overall image or pattern across the collection of pieces.

In an embodiment, the printed indicia comprises flavor, a sweetener, a food acid or salt thereof, a high intensity sweetener, a sensate, or a combination thereof.

The features and advantages are more fully shown by the following examples which are provided for purposes of illustration, and are not to be construed as limiting the invention in any way.

### EXAMPLES

### Example 1

### Preparation of a Sorbitol Pre-Blend Ingredient

Pre-blend ingredients are prepared from powdered sorbitol of varying morphology and particle size according to the formulations in Table 1.

TABLE 1

| Pre-blend | A | B | C | D | E | F |
|---|---|---|---|---|---|---|
| Sorbitol | 45-55 | — | 45-55 | — | — | — |
| powder | | | | | | |
| Roquette P60A | | | | | | |
| Sorbitol | — | 45-55 | — | 45-55 | — | — |
| powder | | | | | | |
| Roquette P60W | | | | | | |
| Sorbitol | — | — | — | — | 45-55 | 45-55 |
| Powder, | | | | | | |
| fine Cargill | | | | | | |
| C*Sorbidex ™ | | | | | | |
| Maltitol syrup | 20-25 | 20-25 | — | — | 20-25 | — |
| Polyglucitol | — | — | 20-25 | 20-25 | — | 20-25 |
| syrup | | | | | | |
| Polyethylene | 4.5-6 | 4.5-6 | 4.5-6 | 4.5-6 | 4.5-6 | 4.5-6 |
| Glycol (PEG | | | | | | |
| 1000) | | | | | | |
| Sodium | 0-4.5 | 0-4.5 | 0-4.5 | 0-4.5 | 0-4.5 | 0-4.5 |
| stearate | | | | | | |
| Hydrogenated | 1.5-4.5 | 1.5-4.5 | 1.5-4.5 | 1.5-4.5 | 1.5-4.5 | 1.5-4.5 |
| vegetable fat | | | | | | |
| Emulsifier | 0.5-2.0 | 0.5-2.0 | 0.5-2.0 | 0.5-2.0 | 0.5-2.0 | 0.5-2.0 |
| Glycerin | 0-15 | 0-15 | 0-15 | 0-15 | 0-15 | 0-15 |
| Liquid flavor | 1-6 | 1-6 | 1-6 | 1-6 | 1-6 | 1-6 |
| High intensity | 0-2.0 | 0-2.0 | 0-2.0 | 0-2.0 | 0-2.0 | 0-2.0 |
| sweetener | | | | | | |
| Inorganic | 0-3 | 0-3 | 0-3 | 0-3 | 0-3 | 0-3 |
| powder (talc, | | | | | | |
| silica) | | | | | | |
| Total | 100 | 100 | 100 | 100 | 100 | 100 |

The sugar alcohol syrup is blended with glycerin at a temperature of 80-85° C. followed by the addition of the sorbitol powder and mixed at 80-85° C. until the powder dissolves. Then the fat emulsifier is added with mixing. The mixture is allowed to cool to 50-60° C. and the flavor, high intensity sweetener and other ingredients are added with mixing to form the pre-blend.

### Example 2

### Chewing Gum Comprising a Sorbitol Pre-Blend Ingredient

Six chewing gums are prepared from 30 wt % gum base, 66 wt % a Sorbitol Pre-blend Ingredient of Example 1, 2 wt % high intensity sweetener, and 2 wt % powdered flavor. The chewing gums are prepared by melting the gum base, blending the gum base with the pre-blend ingredient, high intensity sweetener, and powdered flavor to form chewing gum compositions.

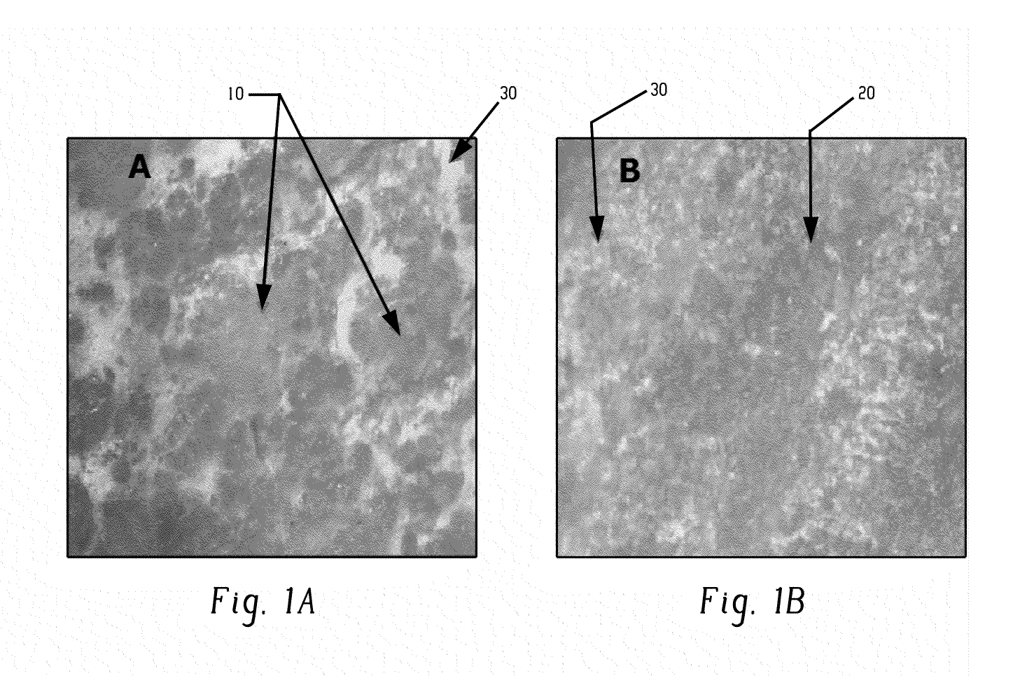

FIG. 1A is a microscopy image of a traditional chewing gum made with crystalline powder sorbitol. Large particles of sorbitol crystals (10) are adhered together with gum base (30). FIG. 1B is a microscopy image of a chewing gum made with a sorbitol pre-blend where the sorbitol particles have been dissolved in the pre-blend. Uniform distribution of gum base (30) and sorbitol in partially dissolved form without large particles (20) is seen.

As used herein the terms “comprising” (also “comprises,” etc.), “having,” and “including” is inclusive (open-ended) and does not exclude additional, unrecited elements or method steps. The singular forms “a,” “an,” and “the” include plural referents unless the context clearly dictates otherwise. The endpoints of all ranges directed to the same characteristic or component are independently combinable, and inclusive of the recited endpoint. The term “a combination thereof” is inclusive two or more components of the list. The term “homogeneous” refers to a uniform blend of the components. The term “or” means “and/or.” Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A chewing gum composition, comprising:
a composition comprising a gum base; and
a flavor pre-blend comprising i) a saccharide syrup or sugar alcohol syrup, ii) a viscosity enhancing agent that is protein, a hydrocolloid, talc, a polysaccharide, a polyethylene glycol, or a combination thereof, iii) an emulsifier, iv) a flavorant, v) a fat, and optionally vi) a food acid or salt thereof, a high intensity sweetener, a sensate, or a combination thereof;
wherein the flavor pre-blend is prepared prior to combining with the composition comprising a gum base to form the chewing gum composition; or
wherein the chewing gum composition releases more flavor than a comparative chewing gum having identical type and amount of ingredients, wherein the ingredients i)-vi) are not prepared as a pre-blend.

2. (canceled)

3. The chewing gum composition of claim 1,
wherein the flavor pre-blend further comprises a humectant;
wherein the flavor pre-blend is present in an amount of about 5 to about 65 wt % of the total chewing gum composition; and
wherein the flavor pre-blend is prepared separately from the composition comprising a gum base and a bulk sweetener at a temperature less than or equal to 85° C., and then combined with the composition comprising a gum base and a bulk sweetener to form a homogeneous chewing gum composition.

4. The chewing gum of claim 1, wherein the viscosity enhancing agent is a plant exudate, a seed gum, a seaweed extract, a modified cellulose, a modified starch, a modified natural gum derivative, or a combination thereof.

5. The chewing gum of claim 1, wherein the viscosity enhancing agent is pectin, gum arabic, acacia gum, an alginate, agar, a carageenan, guar gum, xanthan gum, locust bean gum, gelatin, gellan gum, a galactomannan, tragacanth gum, karaya gum, curdlan, konjac, chitosan, xyloglucan, beta glucan, furcellaran, gum ghatti, tamarin, propylene glycol alginate, carboxymethyl locust bean gum, low methoxyl pectin, microcrystalline cellulose, carboxymethlcellulose (CMC), methylcellulose (MC), hydroxypropylmethylcellulose (HPMC), hydroxypropylcellulose (MPC), a polyethylene glycol, or a combination thereof.

6. The chewing gum of claim 1, wherein
the viscosity enhancing agent is present in the flavor pre-blend in an amount of about 5.0 to about 40 wt % based on the total weight of the flavor pre-blend;
the flavor pre-blend comprises the saccharide syrup or sugar alcohol syrup in an amount of about 30 to about 75 wt % based on the total weight of the flavor pre-blend;
the flavor pre-blend comprises a flavorant in an amount of about 0.01 to about 20 wt % based on the total weight of the flavor pre-blend;
the flavor pre-blend comprises a fat in an amount of about 2.5 to about 10 wt % based on the total weight of the flavor pre-blend;
the flavor pre-blend comprises an emulsifier in an amount of about 1.0 to about 15 wt % based on the total weight of the flavor pre-blend;
the flavor pre-blend further comprises a humectant in an amount of about of about 0.1 to about 30 wt % based on the total weight of the flavor pre-blend; or
any combination thereof.

7. The chewing gum of claim 1, wherein the sugar alcohol syrup is a non-crystallizing syrup.

8. The chewing gum of claim 1, wherein the sugar alcohol syrup of the flavor pre-blend is a hydrogenated starch hydrolysate syrup, an isomaltulose syrup, a maltitol syrup, a sorbitol syrup, a polyglucitol syrup, or a combination thereof.

9. The chewing gum of claim 1, wherein the saccharide syrup comprises sucrose, dextrose, maltose, dextrin, xylose, ribose, glucose, mannose, galactose, fructose (levulose), lactose, invert sugar, fructo oligo saccharide, partially hydrolyzed starch, high fructose corn syrup, polydextrose, or a combination thereof.

10-16. (canceled)

17. A chewing gum composition, comprising:
a composition comprising a gum base; and
a flavor pre-blend comprising i) a particulate saccharide or particulate sugar alcohol, ii) an amount of humectant sufficient to wet the particulate saccharide or particulate sugar alcohol wherein the humectant is glycerin, propylene glycol, or a combination thereof, iii) an emulsifier, iv) a flavorant, v) a fat, and optionally vi) water, a food acid or salt thereof, a high intensity sweetener, a sensate, or a combination thereof;
wherein the flavor pre-blend is prepared prior to combining with the composition comprising a gum base to form the chewing gum composition; or
wherein the chewing gum composition releases more flavor than a comparative chewing gum having identical type and amount of ingredients, wherein the ingredients i)-vi) are not prepared as a pre-blend.

18. (canceled)

19. The chewing gum composition of claim 17,
wherein the flavor pre-blend is present in an amount of about 5 to about 65 wt % of the total chewing gum composition; and
wherein the flavor pre-blend is prepared separately from of the composition comprising a gum base and a bulk sweetener at a temperature less than or equal to 85° C., and then combined with the composition comprising a gum base and a bulk sweetener to form a homogeneous chewing gum composition.

20. The chewing gum of claim 17, wherein
the humectant is present in an amount of about 30 to about 75 wt % based on the total weight of the flavor pre-blend;
the flavor pre-blend comprises a particulate saccharide or particulate sugar alcohol in an amount of about 5.0 to about 40 wt % based on the total weight of the flavor pre-blend;
the flavor pre-blend comprises a flavorant in an amount of about 0.01 to about 20 wt % based on the total weight of the flavor pre-blend;
the flavor pre-blend comprises a fat in an amount of about 2.5 to about 10 wt % based on the total weight of the flavor pre-blend;
the flavor pre-blend comprises an emulsifier in an amount of about 1.0 to about 15 wt % based on the total weight of the flavor pre-blend; or
any combination thereof.

21. The chewing gum of claim 17, wherein the particulate sugar alcohol of the flavor pre-blend is erythritol, galactitol, a hydrogenated starch hydrolysate, isomalt, lactitol, maltitol, mannitol, polyglycitol, sorbitol, xylitol, or a combination thereof.

22. (canceled)

23. The chewing gum of claim 17, wherein particulate saccharide of the flavor pre-blend is sucrose, dextrose, maltose, dextrin, xylose, ribose, glucose, mannose, galactose, fructose (levulose), lactose, fructo oligo saccharide, partially hydrolyzed starch, or a combination thereof.

24-29. (canceled)

30. A chewing gum composition, comprising:
a composition comprising a gum base; and
a flavor pre-blend comprising i) a saccharide syrup or sugar alcohol syrup, ii) a particulate saccharide, particulate sugar alcohol, or a combination thereof, iii) a viscosity enhancing agent that is a protein, a hydrocolloid, talc, a polysaccharide, a polyethylene glycol, or a combination thereof, iv) a flavorant, v) a fat, and optionally vi) a food acid or salt thereof, a high intensity sweetener, a sensate, or a combination thereof;
wherein the flavor pre-blend is prepared prior to combining with the composition comprising a gum base to form the chewing gum composition, and
wherein the flavor pre-blend is free of an emulsifier.

31. The chewing gum composition of claim 30,
wherein the flavor pre-blend optionally comprises a humectant;
wherein the flavor pre-blend is present in an amount of about 5 to about 65 wt % of the total chewing gum composition; and
wherein the flavor pre-blend is prepared separately from of the composition comprising a gum base and a bulk sweetener at a temperature less than or equal to 85° C., and then combined with the composition comprising a gum base and a bulk sweetener to form a homogeneous chewing gum composition.

32. (canceled)

33. The chewing gum of claim 30, wherein the viscosity enhancing agent is a plant exudate, a seed gum, a seaweed extract, a modified cellulose, a modified starch, a modified natural gum derivative, a polyethylene glycol, or a combination thereof; and
wherein the viscosity enhancing agent is present in the flavor pre-blend in an amount of about 5.0 to about 40 wt % based on the total weight of the flavor pre-blend.

34-35. (canceled)

36. The chewing gum of claim 30, wherein the sugar alcohol syrup of the flavor pre-blend is a hydrogenated starch hydrolysate syrup, an isomaltulose syrup, a maltitol syrup, a sorbitol syrup, a polyglucitol syrup, or a combination thereof; and
wherein the saccharide syrup comprises sucrose, dextrose, maltose, dextrin, xylose, ribose, glucose, mannose, galactose, fructose (levulose), lactose, invert sugar, fructo oligo saccharide, partially hydrolyzed starch, high fructose corn syrup, polydextrose, or a combination thereof.

37. (canceled)

38. The chewing gum of claim 30, wherein
the flavor pre-blend comprises the saccharide syrup or sugar alcohol syrup in an amount of about 30 to about 75 wt % based on the total weight of the flavor pre-blend;
the flavor pre-blend comprises a flavorant in an amount of about 0.01 to about 20 wt % based on the total weight of the flavor pre-blend;
the flavor pre-blend comprises a fat in an amount of about 2.5 to about 10 wt % based on the total weight of the flavor pre-blend;
the flavor pre-blend further comprises a humectant in an amount of about of about 0.1 to about 30 wt % based on the total weight of the flavor pre-blend; or
any combination thereof.

39-44. (canceled)

45. A chewing gum composition, comprising:
about 20 to about 50 wt % of a gum base; and
about 20 to about 70% of a pre-blend, wherein the pre-blend comprises i) a sugar alcohol derived from a particulate sugar alcohol, ii) a saccharide syrup or sugar alcohol syrup, iii) an emulsifier, iv) a fat, and optionally v) a flavorant, a humectant, a food acid or salt thereof, a high intensity sweetener, a sensate, an inorganic powder, or a combination thereof;
wherein the pre-blend is prepared prior to combining with the gum base to form the chewing gum composition;
wherein the pre-blend comprises about 4 to about 10% moisture; and
wherein the particulate sugar alcohol is wetted or dissolved by the saccharide syrup, sugar alcohol syrup, or a combination thereof.

46. The chewing gum composition of claim 45,
wherein the pre-blend further comprises a humectant that is glycerin, propylene glycol, or a combination thereof.

47. The chewing gum of claim 45, wherein the particulate sugar alcohol is sorbitol.

48. The chewing gum of claim 45, wherein the particulate sugar alcohol is erythritol, galactitol, a hydrogenated starch hydrolysate, isomalt, lactitol, maltitol, mannitol, polyglycitol, sorbitol, xylitol, or a combination thereof.

49. The chewing gum of claim 45, wherein
the pre-blend comprises the particulate sugar alcohol in an amount of about 35 to about 60 wt % based on the total weight of the pre-blend;
the pre-blend comprises the saccharide syrup or sugar alcohol syrup in an amount of about 10 to about 30 wt % based on the total weight of the pre-blend;
the pre-blend comprises an emulsifier in an amount of about 0.1 to about 10 wt % based on the total weight of the pre-blend;
the pre-blend comprises a fat in an amount of about 1.0 to about 10 wt % based on the total weight of the pre-blend;
the pre-blend comprises a humectant in an amount of about 0.1 to about 30 wt % based on the total weight of the pre-blend;
the pre-blend comprises a liquid flavorant in an amount of about 0.01 to about 20 wt % based on the total weight of the pre-blend; or
any combination thereof.

50. (canceled)

51. The chewing gum of claim 45, wherein the sugar alcohol syrup of the pre-blend is a hydrogenated starch hydrolysate syrup, an isomaltulose syrup, a maltitol syrup, a sorbitol syrup, a polyglucitol syrup, or a combination thereof; and
wherein the saccharide syrup comprises sucrose, dextrose, maltose, dextrin, xylose, ribose, glucose, mannose, galactose, fructose (levulose), lactose, invert sugar, fructo oligo saccharide, partially hydrolyzed starch, high fructose corn syrup, polydextrose, or a combination thereof.

52-60. (canceled)

61. The chewing gum of claim 1, wherein the chewing gum comprises the flavor pre-blend in an amount of about 5 to about 70 wt % based on the total weight of the chewing gum; and
wherein the chewing gum comprises the gum base in an amount of about 5 to about 70 wt % based on the total weight of the chewing gum.

62. (canceled)

63. The chewing gum of claim 1, wherein the chewing gum further comprises a bulk sweetener, wherein the bulk sweetener is a sugar polyol or a saccharide; and
wherein the chewing gum comprises the bulk sweetener in an amount of about 5.0 to about 85 wt % based on the total weight of the chewing gum.

64. (canceled)

65. The chewing gum of claim 45, wherein the chewing gum does not contain a bulk sweetener other than the saccharide or sugar polyol of the pre-blend.

66. (canceled)

67. A method of making a chewing gum composition, comprising:
mixing gum base, optionally with a bulk sweetener, to form an intermediate chewing gum composition; and
mixing the intermediate chewing gum composition with a flavor pre-blend or pre-blend according to claim 1 to form a chewing gum composition.

68. The method of claim 67, wherein the flavor pre-blend or pre-blend is prepared by blending the flavor pre-blend or pre-blend ingredients wherein the process is conducted entirely at a temperature less than or equal to 85° C.

69. (canceled)

70. A chewing gum product, comprising the chewing gum composition of claim 1.

71-74. (canceled)
